(19) United States
(12) Patent Application Publication
(10) Pub. No.: US 2007/0096694 A1
(43) Pub. Date: May 3, 2007

(54) REMOTE STATE OF CHARGE MONITORING

(76) Inventor: Joseph Barrella, Yonkers, NY (US)

Correspondence Address: ISRAEL NISSENBAUM, 1038-56TH ST, BROOKLYN, NY, 11219, US

(21) Appl. No.: 11/532,077

(22) Filed: Sep. 14, 2006

Related U.S. Application Data
(60) Provisional application No. 60/716,834, filed on Sep. 14, 2005.

(51) Int. Cl. H02J 7/00

(52) U.S. Cl. 320/132

(57) ABSTRACT

A method and device for the remote interrogation of batteries and individual cells and remote determination of state of charge of such cells and batteries. The device comprises a capacity measurement element (or alternatively a voltage determiner with correlation to capacity) as commonly used with such cells or batteries, with an electronic analog or digital output. The measurement element is linked to a transmitter element such as radio frequency (RF), bluetooth and infra red (IR) transmission elements (if the containing device is permeable by IR) or other similar electronic remote transmission means. Individual cell identification circuitry correlates the transmission to a particular battery. The device further comprises a receiver which triggers the transmission and which remotely displays the state of charge information.

### FIELD OF THE INVENTION

This invention relates to methods and devices used in determining the state of charge of electrochemical cells or batteries (hereinafter collectively referred to as “batteries”) and in particular batteries internally imbedded or positioned within devices being powered thereby.

### BACKGROUND OF THE INVENTION

Determination of state of charge is important with respect to the utilization of both primary and secondary (rechargeable) batteries. A user needs to know whether a battery is fit for use, when a primary battery is near the end of its useful life and requires replacement and whether replacement batteries need to be at hand. Knowledge of state of charge is even more critical for secondary cells/battery use since recharging generally requires an available electrical outlet or other power source and charging time with the battery or batteries being kept in a reasonable state of charge. In fact, battery chargers are almost all universally provided with state of charge indicators. Furthermore, for common batteries such as NiCd batteries it is also advisable to know state of charge aside from extremes of “discharged” and “charged” in order to avoid charging before deep discharge and occurrence of a memory defect.

Because of its significance there are a plethora of state of charge indicator devices which range from voltmeters, charge detectors and battery testers which detect a voltage drop, indicative of imminent loss of battery capacity, to resistive elements which comprise color indicators on a scale of state of charge. Alternatively, devices often have integrated battery testing elements such as in shavers and handheld or portable electronic devices such as computer laptops and PDAs. More advanced batteries, particularly the more expensive lithium containing type, have been provided with integrated electronic voltage and capacity sensors and microchip circuitry. However, the prior art state of charge expedients all require either direct access to the batteries or battery terminals (with removal from devices) or alternatively the batteries must be used in devices having integrated externally accessible state of charge indicators or readers. Thus, in applications of imbedded batteries, without access to the batteries or their terminals and in devices without state of charge indicators, it is necessary to periodically remove the batteries from the devices to determine state of charge of the batteries or individual cells or to make the terminals accessible for testing connection.

### SUMMARY OF THE INVENTION

It is therefore an object of the present invention to provide a method and device for remotely monitoring state of charge of batteries and individual cells therein regardless of application and device the batteries are used in conjunction with.

This and other objects, features and advantages of the present invention will become more evident from the following discussion and drawings in which:

### SHORT DESCRIPTION OF THE DRAWINGS

FIG. 1 is a cell with an electronic state of charge indicator thereon with the indicator linked to a radio frequency (RF) transmitter in accordance with the present invention.

FIG. 2 depicts the cell as contained within an electrically powered device, e.g. a camera, as shown in dotted line.

FIG. 3 depicts a remote interrogator with interrogation of state of charge of the individual cells and the battery of FIGS. 1 and 2.

### DETAILED DESCRIPTION OF THE INVENTION

Generally the present invention comprises a method and device for the remote interrogation of batteries and individual cells and remote determination of state of charge of such cells and batteries. The device comprises a digital capacity measurement element (or alternatively a voltage determiner with correlation to capacity) as commonly used with such cells or batteries. The measurement element may optionally comprise a visual element of the state of charge though it may be dispensed with for compactness and cost. The measurement element is linked to a commercially available transmitter element. The most common of such transmission elements are radio frequency (RF), bluetooth and infra red (IR) transmissions (if the containing device is permeable by IR) or other similar electronic remote transmission means.

Radio frequency or RF as used herein is a recognized standard having characteristics such that, if the current is input to an antenna, an electromagnetic (EM) field is generated suitable for wireless broadcasting and/or communications. When an RF current is supplied to an antenna, it gives rise to an electromagnetic field that propagates through space as a “radio wave.” Many types of wireless devices make use of RF fields. Cordless and cellular telephone, radio and television broadcast stations, satellite communications systems, and two-way radio services all operate in the RF spectrum. Some wireless devices operate at IR or visible-light frequencies, whose electromagnetic wavelengths are shorter than those of RF fields. Examples include most television-set remote-control boxes, some cordless computer keyboards and mice, and a few wireless hi-fi stereo headsets.

Bluetooth is a telecommunications industry specification that describes how mobile phones, computers, and personal digital assistants (PDAs) can be interconnected using a short-range wireless connection. Bluetooth requires that a low-cost transceiver chip be included in each device. The tranceiver transmits and receives in a previously unused frequency band of 2.45 GHz. The maximum range is 10 meters. A frequency hop scheme allows devices to communicate even in areas with a great deal of electromagnetic interference.

Infrared transmission (IR), as described above, refers to energy in the region of the electromagnetic radiation spectrum at wavelengths longer than those of visible light, but shorter than those of radio waves. Infrared is used in a variety of wireless communications, monitoring, and control applications. Since it operates in the visible spectrum, for IR applications in accordance with the present invention, a line of sight should be available for state of charge data transmission.

A common conversion element converts either an analog or digital state of charge measurement to an appropriate transmission signal, such as described, which is reconverted to the analog or digital measurement by a remote interrogation device and receiver. Digital to digital transmission and conversions are preferred because of reduced cost and more reliable operability, though analog measurements and transmission are within the purview of the present invention. It is of course preferred that all of the elements of measurement element, converter and transmitted be of minimal size especially is space restricted applications and integrated in a single unit and attached to individual cells and/or to a battery as a unit depending on electrical configuration. The state of charge indication may be in a percentage capacity in a digital format or as a gauge in an analog format.

Optionally, but of significant value in situations wherein more than one battery is interrogated, the device further comprises unique cell identification means operable to pinpoint battery position or a queue of batteries and to thereby obviate overlapping signals or cross talk whereby the batteries can be specifically linked to the charge reading. The cell identification means are unique tags identified with the cells or batteries and draw minimal power therefrom for signal power transmission. If necessary, the transmission is effected with a powered filtering to filter out any noise generated by the electrical field of the battery.

The interrogator of the state of charge, in accordance with the present invention, comprises a transmission receiver and activator to activate the transmitter on the battery (a bluetooth connection effects this on an automatic basis). The battery transmitter is preferably activated with a small drain of the battery power and preferably remains on only as long as interrogation remains effective. The interrogator has a display screen, either integrated therewith or electrically connected thereto. In a preferred embodiment the interrogator comprises a PDA having appropriate software and communication means such as with IR or Bluetooth which are resident on many PDAs.

### DETAILED DESCRIPTION OF THE PREFERRED EMBODIMENT AND THE DRAWINGS

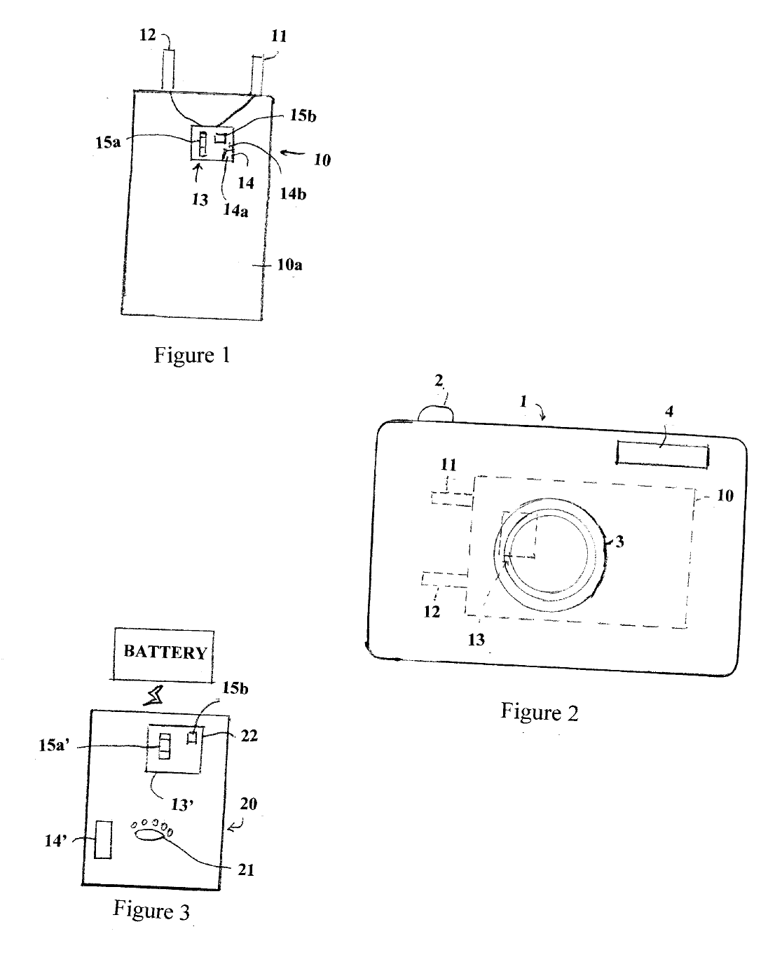

With reference to the drawings, FIG. 1 depicts a typical pouch cell 10 such as a lithium ion cell with terminal tabs 11 and 12. State of charge detection element 13 is integrated with the cell on a surface 10a thereof. Though the detection element 13 is shown as being connected to the tabs 11 and 12, for clarity, such connection can be readily effected through pouch surface 10a. The connection to the tabs provides both the state of charge measurement and also serves to power electrical elements and circuitry contained within element 13. Detection element 13 is comprised of stage of charge monitoring circuitry contained therein (not shown) with either or both displays 15a (analog-meter-type state of charge—FULL, MEDIUM, LOW) and 15b (digital percentage of capacity remaining). Element 13 further comprises RF transmitter 14 with analog and/or digital conversion circuitry 14a for converting the state of charge measurement the RF transmittable form. Circuitry 14b, powered by battery 10, contains a memory with unique battery identification and impresses it on the emitted signal to avoid cross talk between multiple battery transmissions.

With the battery 10 contained in an electrical device such as camera 1 shown in FIG. 2, the camera functions with shutter 2, lens 3 and viewfinder 4 (and image of view on back) not shown through which a battery state of charge is crudely shown but only when the camera is activated. When interrogated with PDA device 20 shown in FIG. 3, without need for turning on the camera or taking out the battery for testing, the analog and/or digital display 15a′ and 15b′ respectively is readily available for the battery in the camera and in any other device within the area. The battery state of charge is also available for batteries in cameras not having digital state of charge monitoring devices such as AP cameras and the like. Element 13′ of the PDA activates the transmission element 14 of the battery 10 wherein the state of charge signal is transmitted to receiver 14′ for conversion and display on PDA screen 22.

It is understood that the above description and drawings are only illustrative of the present invention and that other structures and arrangement of elements is possible without departing from the scope of the present invention as defined in the following claims.

What is claimed is:

1) A device for the remote monitoring of state of charge of an electrochemical cell or battery, said device comprising a state of charge monitor with an electronic analog or digital state of charge output, said device further comprising receiver means for remotely receiving and displaying said state of charge output, wherein said state of charge monitor is integrated with said cell or battery and electrically connected thereto, and wherein said device further comprises electronic transmission means, means for converting said output to a transmission format for transmission to said remote receiver means.

2) The device of claim 1, wherein said device further comprises means for identifying and correlating said state of charge output to said cell or battery.

3) The device of claim 2, wherein said receiver means comprises means for remotely activating transmission of said state of charge output and wherein said receiver means comprises means for converting said transmission to a readable analog or digital output.

4) The device of claim 3, wwherein said transmission means comprises an RF or a Bluetooth output.

5) The device of claim 3, wherein said transmission means comprises an IR output and wherein there is a line of sight between said transmission means and said receiver means.
